(19) United States
(12) Patent Application Publication
(10) Pub. No.: US 2019/0027914 A1
(43) Pub. Date: Jan. 24, 2019

(54) METHOD OF MANUFACTURING ELECTRICAL FEEDTHROUGH INCLUDING PROCESSES FOR REDUCING STRESS IN PACKAGES HAVING A HIGH-CTE METAL AND LOW-CTE SEALING MATERIAL INTERFACE

(71) Applicant: PA&E, Hermetic Solutions Group, LLC, Wenatchee, WA (US)

(72) Inventors: Hua Xia, Huffman, TX (US); Nelson Settles, East Wenatchee, WA (US); Robert Sawyer, Wenatchee, WA (US)

(21) Appl. No.: 16/009,081

(22) Filed: Jun. 14, 2018

Related U.S. Application Data
(62) Division of application No. 15/376,380, filed on Dec. 12, 2016.

(51) Int. Cl. H02G 15/013; H01B 17/30; H02G 3/22; C21D 1/613; C21D 1/60; C21D 1/58; H01R 43/24; C21D 1/18; C22F 1/10; C22F 1/08; C23C 26/00

(52) U.S. Cl. CPC H02G 15/013; H01B 17/303; H02G 3/22; C21D 1/613; C21D 1/60; C21D 1/58; C23C 26/00; C21D 1/18; C22F 1/10; C22F 1/08; H01R 43/24

(57) ABSTRACT

Methods for use in the manufacture or assembly of an electrical feedthrough to provide a solution to the technical and operational challenges that may arise from use of a high-CTE metal/low-CTE sealing material based assembly or package. In some embodiments, the inventive method includes a thermal tempering and thermal quenching process that is used to create an interfacial layer of the sealing material in which there exists a CTE gradient from sealing material to the metal shell and pin(s). This enables the production of an electrical feedthrough assembly that can tolerate high-CTE mismatch induced mechanical stress over a wide operating temperature range.

### CROSS-REFERENCE TO RELATED APPLICATIONS

This application is a divisional filing of U.S. Non-Provisional application Ser. No. 15/376,380, entitled “Method of Manufacturing Electrical Feedthrough Including Processes for Reducing Stress in Packages Having a High-CTE Metal and Low CTE Sealing Material Interface,” filed Dec. 12, 2016, which is incorporated by reference herein in its entirety for all purposes.

### BACKGROUND

Electrical feedthroughs are commonly used for electrical power or signal transmission lines or for connections to downhole measurement tools, and may be found in aircraft instruments, satellites and spacecraft (among other industries) as part of instrumentation. Conventional Aluminum-alloy based electrical feedthrough packages are advantageous in terms of being light weight, having a relatively high mechanical strength, exhibiting a desirable level of corrosion-resistance, and low cost; unfortunately, such types of electrical feedthroughs are also subject to the limitation of there being only a limited number of available glass-ceramic materials for use in making direct hermetically sealed feedthroughs. Further, a technical barrier in using such materials is the 2-3 times mismatch in coefficients of thermal expansion (CTE) between the Al-alloy and the sealing material, which produces/causes a high degree of mechanical stress at the metal/sealing material interface.

In addition to the high CTE-mismatch that can induce mechanical stress, high density pin-to-pin designs may also add stress from the strain field coupling effect. In an aircraft environment application, for example, an electrical feedthrough fabricated from a high-CTE Al-alloy metal/low-CTE glass-ceramic sealing material assembly may not maintain sufficient structural integrity when the mechanical stress placed on the assembly exceeds the maximum allowable design stress. Previous efforts in solving the problems created by such a relatively high degree of “CTE mismatch” have largely focused on developing a high-CTE sealing material for matching the Al-alloy metal's CTE; however, the developed high-CTE sealing materials cannot be used to make a reliable electronic connector because of unsatisfactory mechanical strength and thermal properties that do not meet the specifications required for the wide range of expected operating temperatures. Another attempt to address this problem has been to use a polymer-based epoxy material to seal an Al-alloy based electrical connector; however, this has been less than optimal as the hermeticity and performance of the feedthrough has been compromised.

Embodiments of the methods are directed to overcoming the limitations associated with conventional approaches to producing electrical feedthroughs combining high-CTE metal and low-CTE sealing material integration, such as Al-alloy and a low-CTE sealing material, both individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key, required, or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to a method or methods that may be used in the manufacture or assembly of an electrical feedthrough to provide a solution to the technical and operational challenges that may arise from use of a high-CTE metal/low-CTE sealing material integrated assembly or package. In some embodiments, the inventive method includes a thermal tempering and thermal quenching process that is used to create an interfacial layer of the sealing material in which there exists a CTE gradient from sealing material to the metal shell and pin(s). This gradient (or varying CTE structure) from a relatively low-CTE sealing material to a relatively high-CTE metal or metal alloy material effectively reduces the CTE mismatch-induced interface stress at the package assembly's interface and also rectifies the non-uniform strain field profile. Embodiments of the inventive methods may further include a low-loading based, low-frequency thermal cycle processing stage for effectively removing the initial high strain field coupling effect or undesirable stress, without introducing significant thermal fatigue and/or a mechanical creeping effect. Use of one or more embodiments of the inventive methods enables the production of electrical feedthrough assemblies that can tolerate high-CTE mismatch induced mechanical stress over a wide operating temperature range.

Aspects or processes that are part of one or more embodiments of the inventive methods for use in manufacturing, assembling, or otherwise processing an electrical feedthrough may include:
Treating (e.g., firing) a metal shell, sealing material, and conductive pin(s) package assembly at a pre-set temperature for a pre-set time duration. The metal shell material may be high-CTE aluminum alloys, stainless steel, Nitronic alloy, or an Inconel alloy. The conductive pin may be high CTE copper or copper alloy, iron alloy steel, NiFeCo alloys, or Inconel for electrical conduction. The sealing material may be low-melting point Pb-oxide or Bi-oxide based insulative oxide material for electrical insulation;
As part of the manufacturing process, using a thermal tempering process to create a CTE gradient (CTE varying) interfacial layer or region that reduces the degree of CTE mismatch between the metal shell or pin(s) and the surrounding sealing material, and as a result, the induced interface stress signature, and functions to rectify/reduce the non-uniform strain field amplitude;
To optimize such a thermal tempering process, using a varied thermal quenching rate to form an interfacial layer or region in which the glass-transition-temperature varies—this can be used to create a gradually decreasing density within the sealing material, thereby creating a gradually increasing the CTE value from the sealing material boundary to the metal or metal-alloy shell or to pin(s) interface;
As part of the post manufacturing process, in order to effectively rectify the stress signatures between the high-CTE and low-CTE material interfaces, using a low thermal loading cycle process to enable the manufactured package to be represented functionally as a harmonic thermal oscillator;
As part of a low-temperature material interface stress rectification process, using a low-frequency thermal cycle with an appropriate strain amplitude, varying from a relatively light tensile strain to a relatively high tensile strain in order to reduce the high strain amplitude under low-temperature operating conditions;
As part of a low-amplitude material interface stress rectification process, using a low-frequency thermal cycle with an appropriate low strain amplitude, varying from a relatively light compressive strain to a relatively light tensile strain in order to reduce the high strain coupling effect that may be induced by either a low-temperature or an elevated temperature operation or processing;
As part of an elevated-temperature material interface stress rectification process, using a low-frequency thermal cycle with an appropriate strain amplitude, varying from a relatively light compressive strain to a relative high compressive strain in order to reduce the high strain coupling effect induced by an elevated temperature operation or processing;
As part of a high-amplitude material interface stress rectification process, using a low-frequency thermal cycle with an appropriate high strain amplitude, varying from a relatively high compressive strain to a relatively high tensile strain in order to enable a manufactured package to harmonically respond to relatively wide temperature variations without suffering from excessive mechanical fatigue and/or mechanical creep deterioration;
Using a combination of one or more of the above noted post manufacturing thermal treatment processes to reduce the inharmonic strain coupling in high-density pin type electrical feedthroughs or connectors in order to relax or reduce CTE-mismatch induced material interface stress signatures between a metal shell or pin(s) and sealing material, by creating a graduated or varying glass composition across or through the sealing material cross section (or a part thereof); or
Using a combination of one or more of the above noted post manufacturing thermal treatment processes to reduce the inharmonic strain coupling that can result from elevated temperature operation, by creating a graduated or varying material microstructure across or through the sealing material cross section (or a part thereof), using controlled crystal nucleation and growth.
   Note that use of any of these methods or combinations thereof provide a relatively low-cost manufacturing methodology for manufacturing or assembling reliable high-CTE metal/low-CTE sealing material directly sealed electrical feedthrough products (note that as used herein, “directly” refers to a process in which a relatively high-CTE (>15 μm/m/° C.) metal contacts a relatively low-CTE (<9 μm/m/° C.) sealing material without the use of an intermediate value CTE metal material, such as Al-alloy explosion bonded with stainless steel). In one embodiment the ratio of High-CTE/low-CTE may be between 1.5 and 2.5. In another embodiment this ratio may be between 2.0 and 3.5.

In one embodiment, the invention is directed to a method of producing an electrical feedthrough assembly, where the method includes:
arranging one or more conductive pins in a region;
encasing the region by a metal shell;
applying a sealing material to the region, the sealing material having an associated value of a coefficient of thermal expansion (CTE), a transition temperature (Tg), wettability, and Young's modulus, and being applied to areas between the one or more conducting pins and to an area between the one or more conducting pins and the shell;
processing the applied sealing material to create a change in the value of the CTE of the sealing material across an area around each of the one or more conducting pins and across at least a portion of the area between the one or more conducting pins and the shell; and
applying a thermal tempering or thermal cycling process to the electrical feedthrough assembly.

In another embodiment, the invention is directed to an electrical feedthrough assembly, where the assembly includes:
one or more conductive pins;
a metal shell surrounding a region containing the one or more conductive pins; and
a layer or layers of a sealing material, the layer or layers including a region or regions in which a value of the sealing material coefficient of thermal expansion (CTE) varies in an area around each of the one or more conducting pins and across at least a portion of an area between the one or more conducting pins and the metal shell.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIGS. 1(A) to 1(C) are diagrams illustrating the components or elements of a conventional multi-pin electrical feedthrough assembly or package and represent an example of a structure or device to which an embodiment of the invention may be applied;

FIG. 1(D) is a Table illustrating certain mechanical and thermal properties of materials (metal and sealing glass or ceramic) that may be used in an electrical feedthrough package or assembly;

FIG. 1(E) is a Table illustrating the thermal conductivity of certain quenching fluids or treatments that may be used in manufacturing an electrical feedthrough package or assembly;

FIGS. 2(A) through 2(D) are diagrams illustrating the strain field coupling that may be present between low-density pins in an electrical feedthrough;

FIGS. 3(A) through 3(D) are diagrams illustrating the strain field coupling that may be present among high-density pins in an electrical feedthrough having a two-dimensional pin arrangement than that shown one-dimensional pin pattern in FIG. 2(A);

FIGS. 4(a) through 4(d) are diagrams illustrating example material interface stress signatures that may originate from the CTE differences between the sealing material and the metal shell or conductive pins;

FIGS. 5(A) and 5(B) are diagrams illustrating the non-uniform strain field profile that may be present in an electrical feedthrough assembly or package;

FIG. 6(A) is a diagram illustrating the mechanical stress accumulated in the feedthrough shell, where the so-called “undesirable stress” appears at extremely low temperatures, and FIG. 6(B) is a diagram illustrating that the sealing material glass transition temperature may also introduce a relatively high stress amplitude at elevated temperatures, where this behavior may limit the maximum operating temperature range for the assembly or package;

FIGS. 7(A) through 7(C) are diagrams illustrating the use of an embodiment of the inventive processes to reduce the stress profile across a multi-pin feedthrough assembly or package by creation of a variation in the CTE across the interface(s) between the sealing material and a pin, and between the metal shell and the sealing material;

FIGS. 8(A) through 8(C) are diagrams illustrating the cooling rate profile of the thermal tempering process described with reference to FIGS. 7(A) through 7(C) for use in reducing the stress profile across a multi-pin feedthrough assembly or package;

FIG. 9 is a flow chart or flow diagram illustrating the steps or stages in a process flow for producing a harmonic thermal oscillator based multi-pin feedthrough in accordance with an embodiment of the inventive processes; and

FIG. 10 is a diagram illustrating how an embodiment of the inventive processes may be used to reduce the compressive stress in a multi-pin feedthrough assembly or package in the low temperature range.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

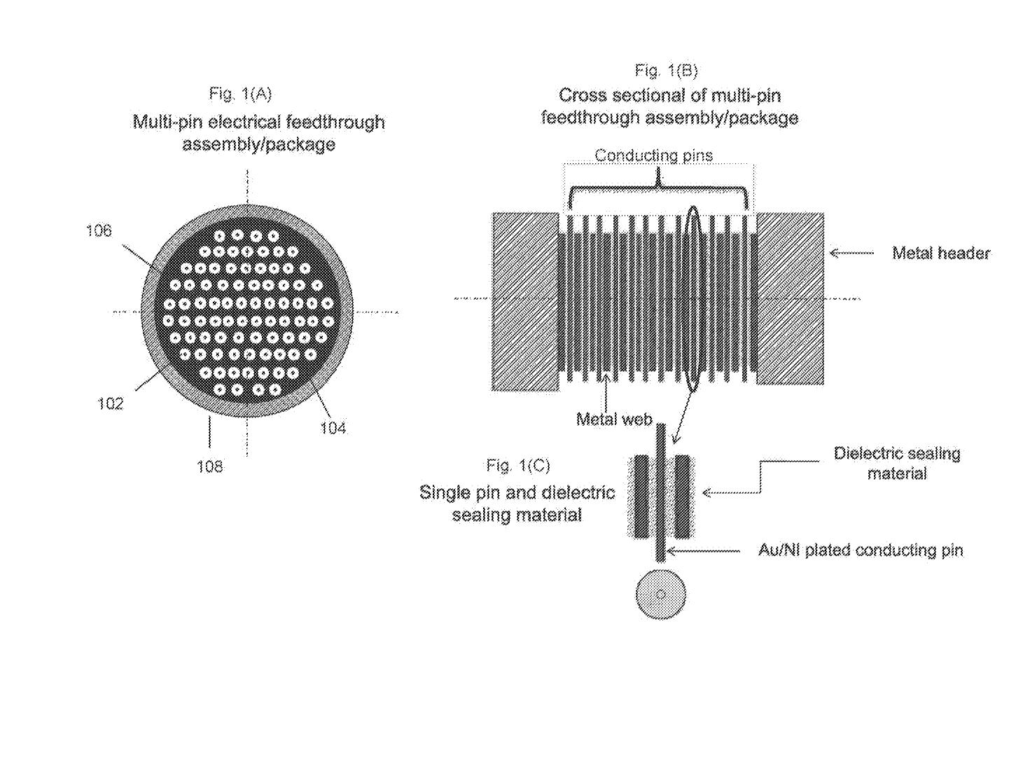

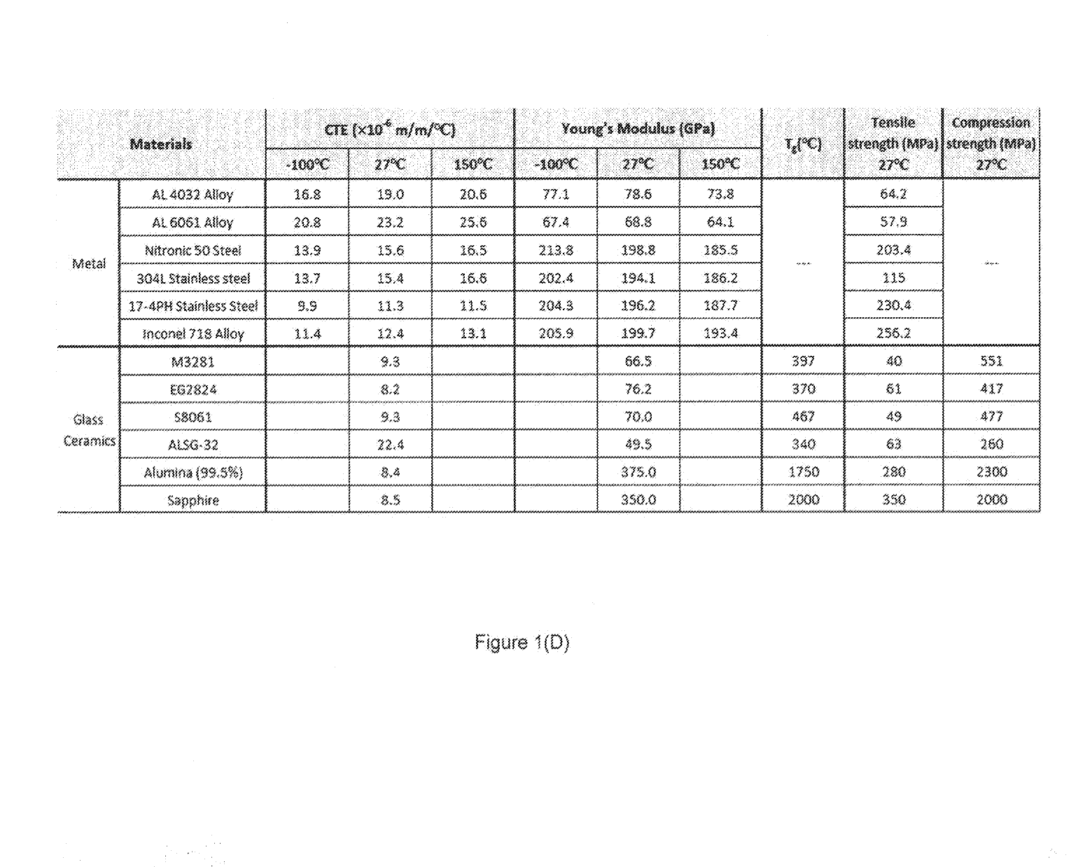

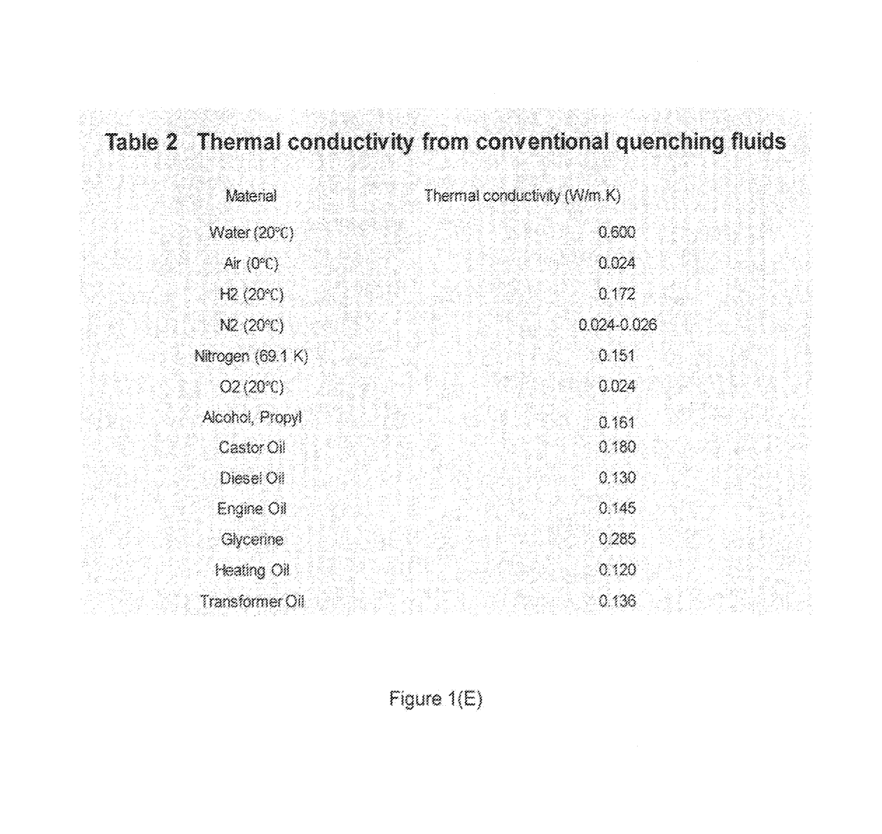

Electrical feedthroughs are widely used in electronic systems or instruments, such as modern aircraft, automobiles, ships and submarines, etc. A feedthrough assembly or package may provide electrical connections between electrical cables and electronic instruments, and allow for easier and faster replacement of cables and components using an array of connectors. A conventional electrical feedthrough typically consists of a mating pair (plug and receptacle), each equipped with male (pin) or female (socket) contacts; note that at least one of the feedthrough halves, or its contacts, is preferably “floating” (i.e., able to undergo a small degree of motion or movement) to reduce mechanical stresses. A metal such as aluminum, titanium, stainless steel, Kovar, Inconel or a composite is used to fabricate the feedthrough shell or header, while one or more of the higher dielectric glasses or ceramics are used as a sealing material. An electrical feedthrough may consist of a single conducting pin or of multiple conducting pins (multi-pin), with a circular or rectangular shell shape surrounding the pins. Each conducting pin is surrounded by a sealing material and functions as an electrical connector at a specific location inside a feedthrough, as shown in FIG. 1(A). Note that the design process for an electrical feedthrough may include the consideration of multiple factors, including the applicable electrical, mechanical, and environmental operating conditions and installation constraints, as well as the requirements for geometry, functionality, reliability, and cost effectiveness of the assembly.

FIGS. 1(A) to 1(C) are diagrams illustrating the components or elements of a conventional multi-pin electrical feedthrough assembly or package and represent an example of a structure or device to which an embodiment of the invention may be applied. As shown in FIG. 1(A), in a typical feedthrough, multiple conducting pins 102 are sealed in a specific pattern on a metal web 104 with a dielectric sealing material 106, which is commonly rated for operation within the range of −55 to +125° C. The metal shell 108 of the assembly or package may be composed of Titanium, Aluminum, stainless steel, Kovar, or an Inconel metal alloy that will meet the environmental/operating requirements with regards to resistance to corrosion, creeping, and mechanical or physical failure. The conducting pins 102 are typically formed from a highly electrical conducting material, such as a copper alloy (e.g., BeCu, CrCu, Brass C26000, Brass C36000), Alloy52, Kovar, Inconel, stainless steel, etc. These pins may be protected by a layer of Nickel plating, and in some cases a bi-layer of Nickel and Gold. Potential sealing materials 106 are limited, and include options such as Borosilicate, Soda-lime, Alumina, Alkaline, Silicate, lead-oxide, Bismuth oxide based glasses, etc., which are commercially available from Schott Glass, Corning, Ferro, 3M, SEM-COM, and various other suppliers.

In a typical multi-pin feedthrough configuration, each pin is embedded in the sealing material and surrounded by a metal “web”. Each pin surface may be subjected to a so-called abrasion process or oxidization process to enhance the chemical/shear bonding strength between the sealing material and the pin surface. In another example, each pin may be plated with a layer of 100-300 micron inch (μIn) thick Nickel as an interior layer, with a 50-150 micron inch (μIn) thick layer of soft/hard Gold as an outer layer. The fired/treated sealing material may be fused onto the pin surface and metal web as a unit; however, the sealing length may vary from pin to pin, leading to a non-uniform stress field or stress signature across the feedthrough assembly.

Successful integration and reliability of the metal shell 108 and sealing material 106 is facilitated if the materials involved have a similar coefficient of thermal expansion (CTE), so that a relatively uniform elastic strain field is present and continuous across the combination of materials and the assembly/package as a whole. However, it has been a challenge within the industry to find a dielectric sealing material that has a matching (or even closely enough matching) CTE to that of a metal material (such as an Aluminum alloy or stainless steel etc.).

FIG. 1(D) is a Table illustrating certain mechanical and thermal properties of materials (metal and sealing glass or ceramic) that may be used in an electrical feedthrough package or assembly. The Table provides mechanical and thermal properties of the indicated metal and sealing materials, and also lists the corresponding glass transition temperature, tensile and compression strengths of the sealing glass-ceramic material. Note that for a metal material, it is possible to find a value for the coefficient of thermal expansion (CTE) and Young's modulus at elevated temperatures, but it is difficult to find those values at lower temperatures. For sealing glass-ceramic materials, one can typically find the Young's modulus and CTE, but it is difficult to find temperature dependent values. From the values in the Table, it is clear that the CTE of most sealing materials is about 2 times smaller than that of steel-based metal alloys, but is nearly 2.5 times smaller than aluminum-based alloys. This can be the source of a significant enough CTE-mismatch between the materials to create a reliability problem, as it is often desirable to use a sealing material to directly seal a high-CTE metal, such as an Al-alloy, as part of producing a low-cost electrical feedthrough package.

One reason that the difference in the properties of the material is of concern is that when a feedthrough package, consisting of two or more materials having different CTE values, is subjected to a mechanical or thermal stress gradient, the metal shell and sealing material tend to expand or contract at different rates (and hence will result in different relative amounts of expansion or contraction) as a function of temperature; this difference creates localized mechanical strain field signatures across the combined conducting pin, sealing material, and metal shell assembly.

By way of explanation, a multi-pin based feedthrough package may be characterized by a set of multi-strain signatures, with a strain field (which represents the strain at a location (r) for a given temperature (T) as a function of time (t)) represented by

ε(r,T,t)=ε(r,T)+ε(r,t), (1)

where the first term ε(r,T) represents the static strain field amplitude at each conducting pin location (r) as a function of temperature, which is the sum of a localized mechanical strain ε(T) and a strain field coupling contribution from adjacent conducting pins Δε(r,T):

ε(r,T)=ε(T)+Δε(r,T), (2)

where each connector pin is located at a radius rₒ. Note that the degree (i.e., significance) of the strain field coupling effect is determined by Δε(r,T). The second term in equation (1)

ε(r,t)=ε(r)·exp(−ωt) (3)

represents a dynamic strain field that is a function of time and propagates across the feedthrough package, and is typically induced by an external environmental condition.

Static strain and dynamic strain are two physical parameters; equation (3) represents a dynamic strain field response to an external environmental excitation (typically of relatively small amplitude, but possibly relatively high frequency or short duration). However, a relatively high external strain amplitude may cause a reliability issue if it results in mechanical fatigue and/or a mechanical creeping effect. Note this term may represent a transient event, such as mechanical shock, and/or laser welding induced thermal shock transient events. Electrical feedthrough package reliability is normally determined by the static (time independent) strain field ε(T), while Δε(r,T) could have a positive effect for a weak compression package or a negative effect as an “undesirable strain” on a strong compression package.

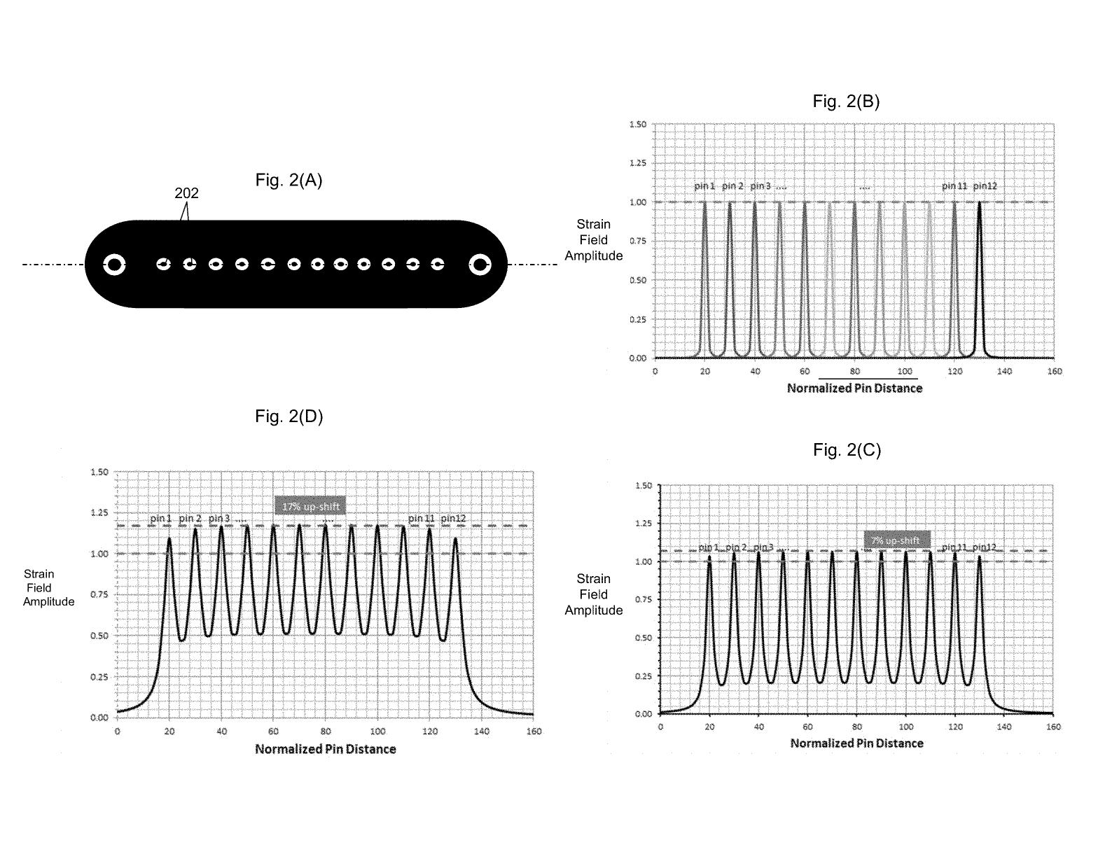

Note that if the dielectric material used in the sealing process has a sufficiently similar CTE as the metal shell material (a so-called “matched design”), then the strain field amplitude would be expected to be relatively low or negligible in value at locations across the surface (and in the interior) of the feedthrough assembly. The arrangement and distribution of the conducting pins can also have an impact on the strain field; when there is a relatively large pin-to-pin separation, each individual connector may have a weak strain around each connector region, and negligible or limited strain field coupling in-between two connectors, as shown in FIGS. 2(A) through 2(D), which are diagrams illustrating the strain field coupling that may be present between pins in an electrical feedthrough assembly.

With reference to FIGS. 2(A) through 2(D), FIG. 2(A) shows a multi-pin feedthrough connector with a relatively larger separation between conducting pins 202. FIG. 2(B) shows the expected strain field in a situation of the strain coupling component being negligible. FIG. 2(C) shows the expected strain field in a situation of the strain coupling being at a relatively low (weak) level. FIG. 2(D) shows the expected strain field in a situation of the strain coupling being at a relatively high (strong) level. From the figures, it is apparent that mechanical stress is strongly dependent on the geometrical design pattern and the potential strain field coupling may cause localized stress that exceeds the maximum allowable design stress or material's maximum tensile/compressive strength(s). As recognized by the inventors, in order to prevent or reduce such strain signatures around each conductive pin, the mechanical and physical properties of the sealing material may need to be constrained with regards to glass transition temperature, hardness, Young's modules, and CTE etc.

Despite the relatively large pin-to-pin separation illustrated in FIG. 2(A), a significant enough CTE mismatch between the metal shell and the dielectric sealing material may still result in a relatively high-strain package because of the CTE-mismatch induced strain field coupling effect. For example, a situation in which there is a relatively high compression in the sealing material and a relatively high tension in the metal material may occur after the firing process as a result of a CTE mismatch, with the impact approximately described by

Δσ(r,T)≈κ(r)·[Eₛₕₑₗₗ·αₛₕₑₗₗ−Eₛₑₐₗ·αₛₑₐₗ]·(T_{g}−T); (4)

where κ(r) is a constant related to Poisson's ratio and the feedthrough geometry and location, E and α are Young's modulus and the CTE of the respective components, and T_{g} is the glass transition temperature of the dielectric glass/ceramic sealing material.

From the expression, it is clear that the CTE (i.e., α), Young's modulus (E), the sealing material glass transition temperature (T_{g}), and the operating temperature (T) are parameters which can determine if a feedthrough package has an adequate (typically meaning relatively high) reliability and service lifetime (by comparing the possible maximum stress value with the material maximum strength). Further, as recognized by the inventors, each of the four parameters can impact the strain field amplitude in a different way.

Note that the glass transition temperature is not a precise value for each type of sealing glass material; rather, it represents a specific temperature range of ±5% T_{g} over which the material morphology transforms from a liquid state to a super cooled solid state. In a specific example, FIG. 2(C) shows that only a 10% increase in the glass transition temperature may increase the strain field amplitude by approximately 7-10%. A relatively high degree of CTE-mismatch of (αₛₕₑ₁₁−αₛₕₑₗₗ)/αₛₕₑₗₗ) 42% between an Al-alloy metal shell and a typical sealing material with a CTE of 11×10⁻⁶ m/m/° C. may increase the strain field amplitude up to 20%, as shown in FIG. 2(D). For a sealing material having a CTE≈7-9×10⁻⁶ m/m/° C., the extra strain field amplitude may increase 30-40%, which would be expected to result in a low reliability for an Al-alloy sealed feedthrough package, because a high-CTE material has a maximum allowable design stress, such as 60-75 MPa for Al alloys for T<−35° C.

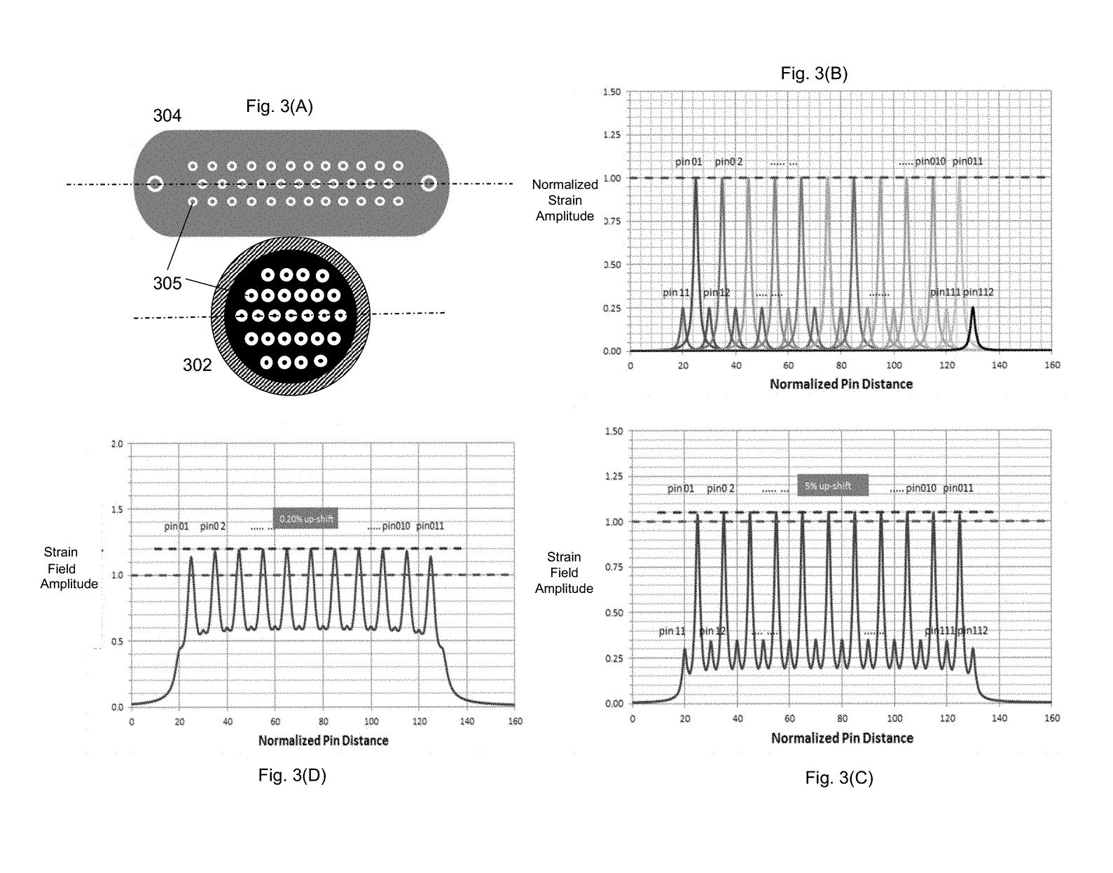

The strain field pattern would be expected to become more complicated in a situation of an array of conducting pins or connectors, as shown in FIG. 3(A), where such a feedthrough package may have a circular pin pattern 302 or a rectangular shape 304, with a relatively high density of conducting pins 305. If the pin-to-pin separation is relatively far apart, then the strain field may still be localized or only lightly coupled, which may not affect reliability and performance, as shown in FIGS. 3(B) and 3(C). But in some cases, a high degree of strain field coupling may occur in a high-density pin array, which may increase the strain field amplitude by 20-30% for a CTE≈11×10⁻⁶ m/m/° C. sealing material that is sealed with an Al-alloy metal, as shown in FIG. 3(D). For a sealing material with a CTE≈7-9×10⁻⁶ m/m/° C., the extra strain field amplitude may increase 30-50%; this would be expected to lead to low reliability for an Al-alloy directly sealed feedthrough package, if the strain amplitude overpasses its maximum allowable design stress of 60-75 MPa for T<−35° C.

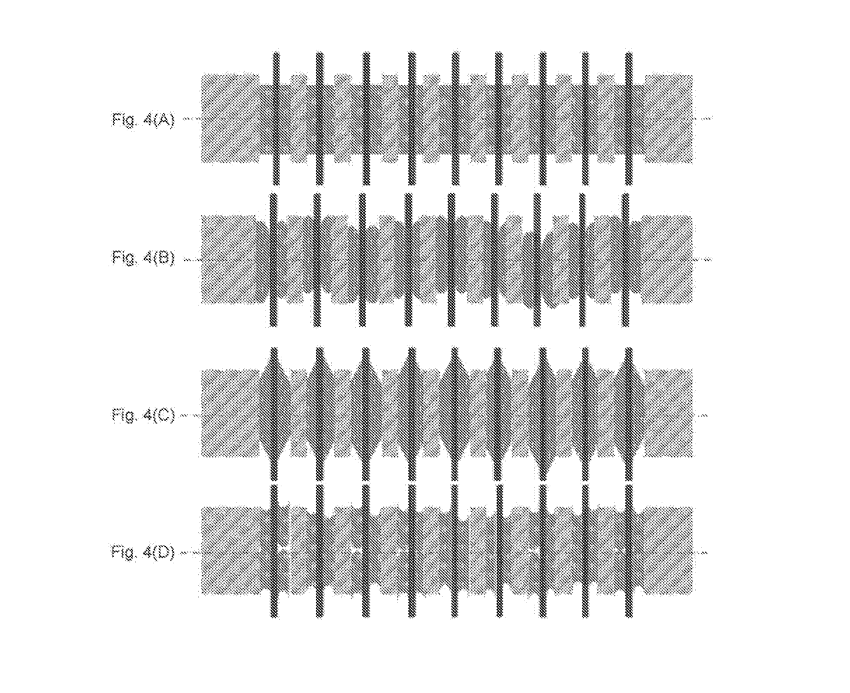

A non-uniform strain field and the resultant stress signatures may also originate from the feedthrough manufacturing process, where the wettability of the sealing material to the metal shell and conductive pin materials, and the varied sealing length are also factors that may act to shorten a feedthrough's service life. FIGS. 4(a) through 4(d) are diagrams illustrating example material interface stress signatures that may originate from the CTE differences between the sealing material and the metal shell or conductive pins. These figures illustrate four scenarios involving the wettability property and sealing length variation observed for a feedthrough assembly. FIG. 4(a) represents an ideal case of the integrated structure cross-section from sealing glass to metal shell and to pin. The transition from the sealing material to metal shell has a discontinuous interface with different materials on two sides. FIG. 4(b) shows a cross-sectional illustration of sealing material in an integrated electrical feedthrough package with a “less desirable” wettability to pin and a preferred wettability to the metal shell, where the sealing length for each pin may vary randomly. FIG. 4(c) illustrates another example of sealing material wettability to pin (in this case “good”) and to the metal shell (in this case “less desirable”). FIG. 4(d) illustrates a high wettability for the sealing material to both a pin and to the metal shell, but the solid insulation body has an under-filled concave shape. In this case, the solid insulation glass-ceramic body may have a relatively sharp contact angle with the metal shell or with a pin surface, which leads to a relatively high stress or cracking seed at these points.

The non-uniform stress that may be induced from one or more of the scenarios illustrated in FIG. 4 may be partially reduced by selecting a sealing material with an appropriate (that is, the best case) wettability with both the metal shell and the conductive pins. Note that the preferred conductive pin materials, such as BeCu, CrCu, Brass, and Ptlr are very different from the feedthrough shell materials, such as Al-alloy, Inconel alloy, stainless steel, etc. Such a difference in material properties may cause the interfaces between the sealing material body, metal shell, and the pin(s) to be quite different from the ideal case, which would be to have randomly distributed mechanical stress throughout the whole feedthrough assembly package, which very often causes hermetical failure after suffering thermal shock from a laser welding process.

The discontinuous or only partially filled interfaces between the sealing material and the metal shell and/or pin(s) typically cause stress signatures that could be the source of cracking seeds under sufficient external mechanical shock or vibration. To mitigate such a wettability (e.g., high stress concentration) concern, the metal shell surface or pin surface may be modified/treated to enable the sealing material to have a stronger chemical or shear bond strength with the shell or pin(s) without introducing stress signatures.

In one embodiment, the metal shell and/or pin surface(s) may be treated using an abrasion process, oxidization process, or a combination of both. In another embodiment, the conductive pin may be plated with a layer of metal film (such as Nickel), a bi-layer of metal films (such as soft/hard Gold on the top of Nickel film), or a tri-layer of metal films (such as soft/hard Gold as an outer layer, Pd/Pd-alloy as a sandwiched layer, and Ni as an internal layer). The thickness of the Gold, Pd/Pd-alloy, and Ni layers may range between 25 to 150 μIn for Gold, 0-150 μIn for Pd or Pd-alloy, and 0-300 μIn for Ni. In the specific example of a non-magnetic pin, the nickel layer is absent, but the Pd or Pd-alloy layer serves as a barrier layer to prevent Cu⁺ or Cu⁺⁺ ion diffusion into the sealing material. In some embodiments, a plated pin surface may be of better wettability to the sealing material without requiring the use of an abrasion or oxidization process.

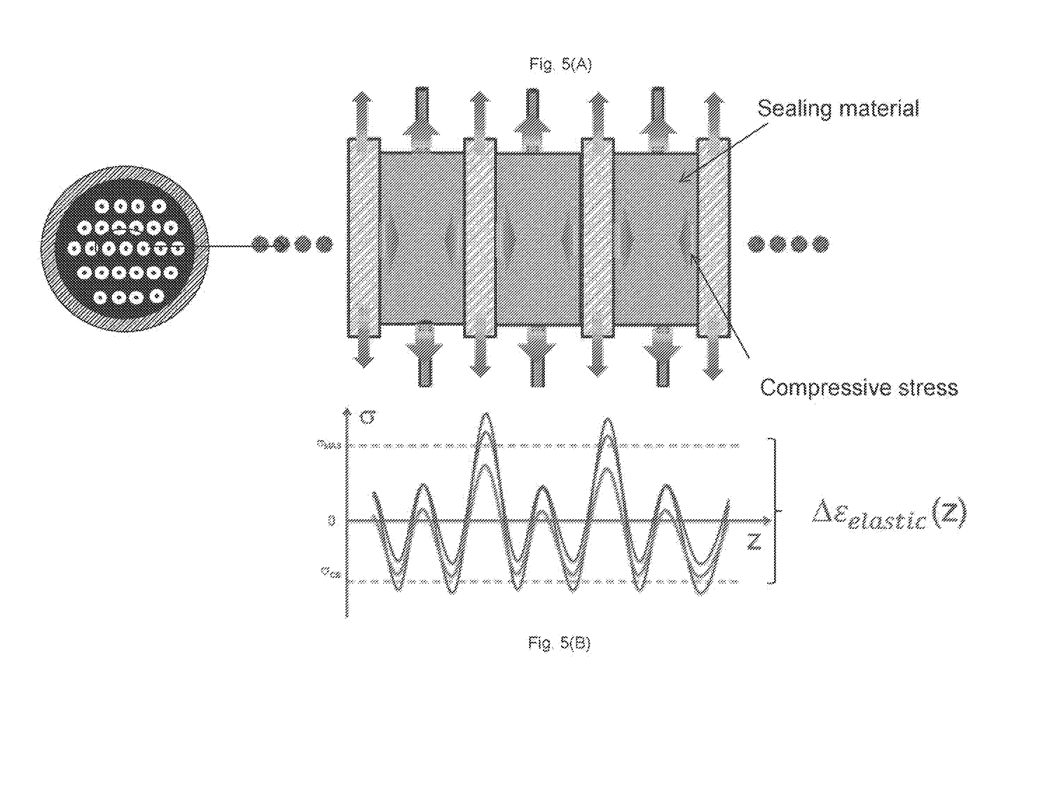

Although the metal shell and pin surface treatments may greatly improve the chemical bond or shear coupling strength between the metal pin surface and the sealing material, these treatments may not provide a solution for the other stress signatures or sufficiently address the strong strain field coupling in a high-density pin feedthrough package, as shown in FIG. 2 and FIG. 3. FIGS. 5(A) and 5(B) illustrate the strain field profile across a feedthrough package following an isothermal firing and cooling process. The CTE-mismatch between the metal and sealing material has led to the creation of a relatively high tensile stress in the metal web region and shell, and a compressive stress in the sealing glass-ceramic material body. After the firing process, the interface area between the metal and sealing material suffers from radial compressive stress and also creates axial tensile stress in the interior of the sealing material. Note that if these stresses are under the sealing material's maximum tensile strength (σₜₛ) and compressive strength (σ_{cs}), as shown by the green curve of FIG. 5(B), then this situation will not be the source of a reliability issue, at least not initially (although it may make the metal/sealing material interfaces more likely to fracture under application of a sufficient external source of stress). Considering the potential sources of stress as discussed with reference to FIGS. 4(b) to 4(d), note that the stress field could be non-uniform across the entire metal web region, with potential stress signature points around certain pins.

In a typical example of an Al-alloy based feedthrough package, the initial tensile stress may be slightly more than the maximum allowable stress σ_{MAS} of the Al-alloy material, but less than the sealing material's compressive strength, as illustrated by the blue curve in FIG. 5(B). In other situations, the initial stress may exceed both the maximum allowable stress of the metal material and the compressive strength of the sealing material, as illustrated by the red curve in FIG. 5(B). The amount of strain amplitude outside the limit(s) of σ_{MAS} and σ_{CS}, defined as “undesirable stress”, may (and often does) contribute to performance failure in the hermetical seal between the metal and sealing materials, and potential moisture or chemical interactions may greatly reduce the effective service lifetime of a feedthrough product.

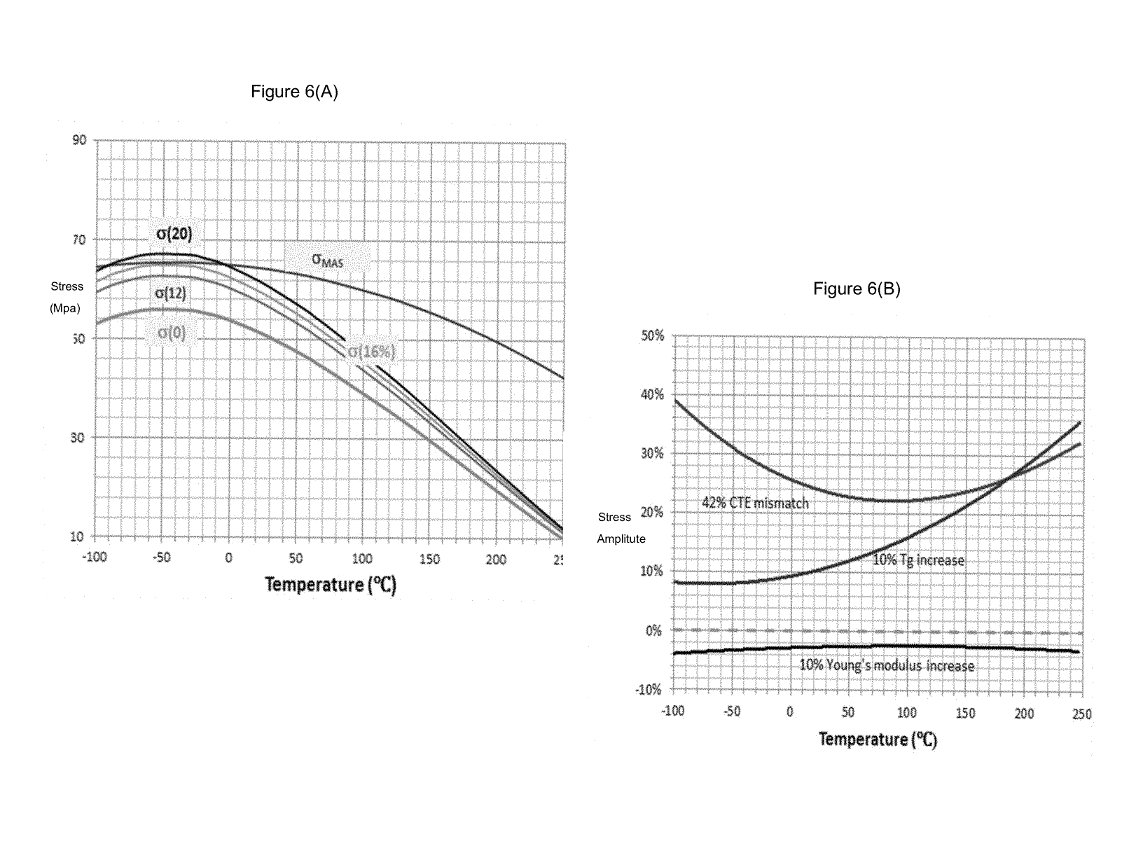

FIGS. 6(A) and 6(B) are diagrams illustrating the mechanical stress accumulated in the metal shell of a feedthrough package, where a degree of the so-called “undesirable stress” appears at sufficiently low temperatures. FIG. 6(A) shows the stress field amplitude as a function of the operating temperature for a high-density multi-pin feedthrough with an Al-alloy as the shell material, BeCu as the conducting pins, and a sealing material with characteristics of α=11×10⁻⁶ m/m/° C., E=50 GPa, and T_{g}≈300° C. Under a negligible strain field coupling effect, the mechanical stress, σ(0), in the Al-alloy shell is lower than the maximum allowable stress σ_{MAS} limit. However, a 20% strain field amplitude increase is possible (as discussed) for a low-CTE sealing material directly sealed to a high-CTE Al-alloy based electrical feedthrough package. This increase may lead to the actual stress field amplitude, σ(20), being greater than the Al-alloy material's maximum allowable stress σ_{MAS}, when T<−35° C. In some cases, the strain field coupling may contribute part of the stress amplitude, while a relatively shorter sealing length may contribute another part of the actual stress amplitude.

As noted, due to the limited number and types of available options of sealing glass or glass-ceramic materials, it presents a technical barrier to find a CTE-matched sealing material for use in manufacturing or assembling high-CTE metal/low-CTE sealing material (such as an Al-alloy based) electrical feedthrough connectors. However, as will be described in greater detail, embodiments of the inventive methods and processes provide ways to manufacture or assemble a reliable electrical feedthrough using a low-CTE sealing material with a high-CTE Al-alloy metal by varying other material properties to prevent the occurrence (or to reduce the impact) of a high stress field.

As recognized by the inventors, one or more of a material's Young's modulus (E), compression strength (σ_{cs}), or glass transition temperature (T_{g}) can be the basis of a process to reduce or prevent the occurrence of undesirable levels of stress. FIG. 6(B) shows that a failure mode is primarily the result of a relatively high CTE-mismatch, which causes an “undesirable stress” level as the operating temperature T<0° C. FIG. 6(B) also shows that both a CTE-mismatch and a higher glass transition temperature (T_{g}) could produce a relatively severe level of stress when T≥150° C. From these figures, it is apparent that the improper selection of a sealing material to directly seal a high-CTE metal may result in a lower reliability, and even a critical operational failure whenever σ(T)>σ_{MAS}, especially when T<−35° C. Note that each of the sealing material properties or design geometry factors may contribute to the stress field variation in varying amplitude(s) at different temperatures. For example, the variation of the Young's modulus doesn't contribute significantly to an existing strain field profile, but the glass transition temperature (T_{g}) may be a significant influence at an elevated temperature, as shown in FIG. 6(B).

For a specific combination of a (relatively) high-CTE metal and a (relatively) low-CTE sealing material used in making a high-density pin feedthrough package, the high strain field and isolated strain signatures (being undesirable stress) should be reduced or compensated for in order to provide greater performance reliability and sufficient service lifetime. The various inventive methods and procedures for removing such “undesirable stresses” during the feedthrough package manufacturing process are described in greater detail in the following sections:

Creating a CTE Gradient Using a “Thermal Tempering Process” for Reducing Interfacial Stress Signatures

The influence of a relatively low-CTE sealing material and a relatively high-CTE metal shell parameters on the strain field amplitude, as shown in FIG. 6(B), indicates that a CTE mismatch could lead to an increase of 30-50% in the strain field amplitude, with the glass transition temperature, T_{g}, being a relatively small factor when T<0° C. However, both CTE mismatch and T_{g} could cause a feedthrough package to have “undesirable σ(T)>σ_{MAS} stress” at elevated temperatures, particularly when T>100° C. At lower temperatures or within a lower temperature range, CTE mismatch is a dominant factor in producing high-stress in the feedthrough package; however, a reduction in the glass transition temperature (T_{g}) may be used to decrease the CTE mismatch induced stress amplitude. As recognized by the inventors, a combination of the CTE mismatch amount, sealing material T_{g}, Young's modulus and a suitable optimization process may be used to improve service lifetime and reliability for high-CTE metal/low-CTE sealing material based electrical feedthroughs.

As further recognized by the inventors, it is desirable that the thermal properties of feedthrough assembly/package (comprising the shell, the pins, and the sealing material) be a continuous volume, similar to a thermal resonator or oscillator, with respect to the variation of certain material properties, and one that expands or contracts relatively gradually and uniformly (rather than allowing each part to expand individually and largely independently of the others, which can cause significant stress), as shown in FIGS. 4(b) through 4(d). This is accomplished in accordance with embodiments of the inventive processes by creating a transition layer having a gradually varying value of the CTE; this transition layer, either by itself or in conjunction with other of the inventive structures or processes, functions to reduce the impact of the possible strain field discontinuities arising from the transition between the relatively high-CTE metal shell to the relatively low-CTE sealing material, and to high-CTE pins.

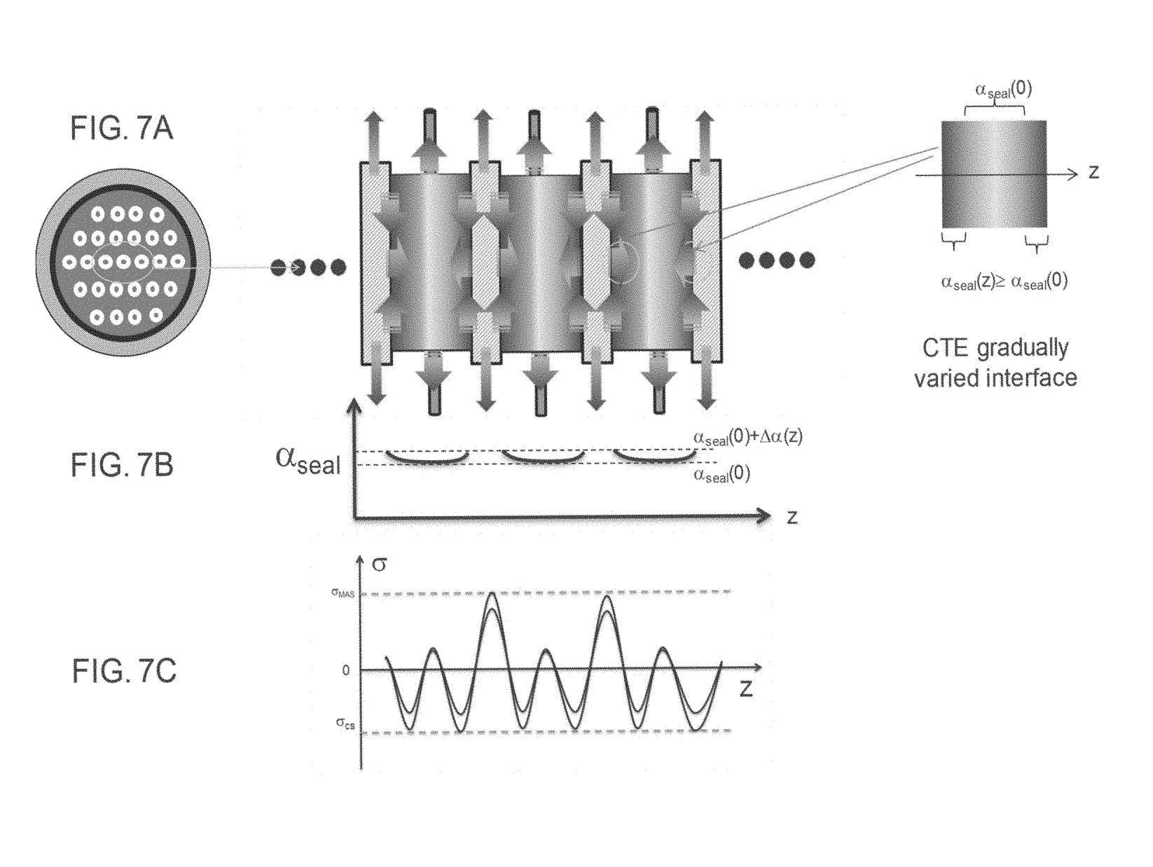

FIG. 7(A) illustrates the results of applying a thermal tempering process (as in some embodiments of the inventive processes) to reduce the impact of a non-uniform strain field distribution, as illustrated in FIG. 5(A). As recognized by the inventors, this thermal tempering process will introduce an axial compressive force at the sealing glass-metal alloy interface (in addition to the radial compressive stress), which will effectively reduce tension in the metal shell, as shown in FIG. 7(C). The transition layer, with a gradually varying CTE (as shown in FIG. 7(B)), has a higher CTE at the metal/sealing glass-ceramic material interface but gradually changes to the “normal” CTE, α(0), of the sealing glass-ceramic material. The same concepts also help to explain the interface structure between the sealing material and pin or the sealing material and an Au/Ni plated pin surface. Note that in addition to the described thermal tempering process or processes, it is possible to create a layer having a varying CTE value for the material using a sputtering process wherein material of different densities is applied to a substrate, or by using ion beam implementation technology to bombard a substrate with high energy photons.

With regards to the thermal tempering process or processes, thermal tempering of an object, such as a sealing glass or glass-ceramic, comprises a heating process and a cooling process. In the case of a sealing glass or glass-ceramic based sealing material, a furnace will be operated at a firing temperature (T_{f}) for a certain length of time to cause the beads of sealing material to be melted down, with an appropriate viscosity and sufficiently wetted to the metal shell and pin surface(s). The thermal tempering process then cools the feedthrough assembly to a quenching fluid temperature (such as T_{q}=−1 96° C. for liquid N₂), under a controllable rate. The heat dissipation from the “hot” feedthrough assembly to the quenching fluid will depend upon the quenching fluid temperature (T_{q}), thermal conductivity (k_{q}), density, and specific heat capacity. The viscosity of the sealing material will vary (typically increase) with a decreased quenching time at a specific T_{q}; the liquid-like sealing material could become “frozen” within a transient time interval. Since the thermal conductivity of the sealing material is relatively low (˜1.0 W/m/K) compared to a metal material (˜300 W/m/K), the heat dissipation rate will be relatively fast at the sealing material surface and slower with increased depth into the sealing material. As the liquid-like sealing material becomes a supercool solid gradually from its outer surface to the interior, the microstructure of the outer layers will vary from a randomly amorphous morphology to a more structured morphology, and eventually to a conventional sealing material structure with increased depth from the interface.

To produce such a CTE gradient (i.e., a varying value of CTE over a defined length, area, or volume) within a transition layer by a thermal tempering process, an important parameter to determine or establish is the initial tempering temperature Tₜₚ, which should be less than the melting point of the metal material, but preferably between the glass frit melting point (Tₘ) and softening point (Tₛ), that is

Tₛ≤Tₜₚ≤Tₘ, (5)

where Tₘ−Tₛ could be from a few tens to a few hundred degrees Celsius for commonly used sealing materials. In one example case, the tempering temperature could be equal to the firing temperature (T_{f}) as used for the feedthrough assembly manufacturing process. A second important aspect is to set a proper cooling rate. The desired cooling rate is a function of time and is described by

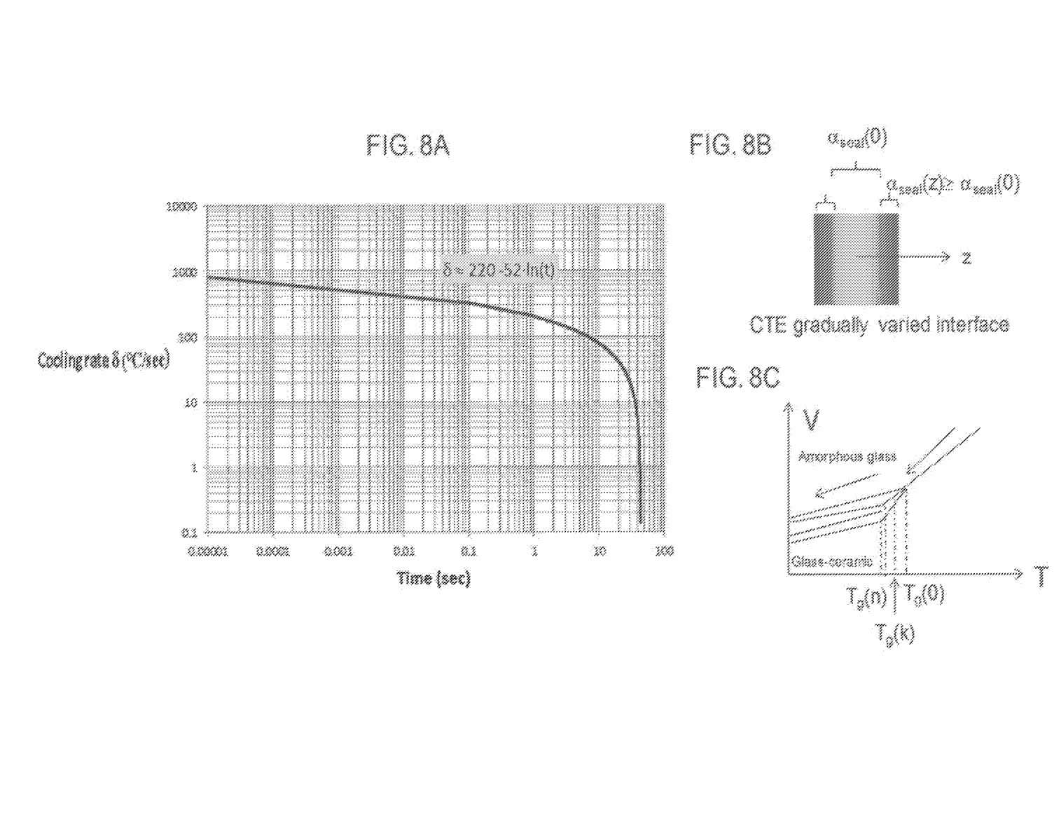

τ(t)=τ(0)·δ(0), (6)

where the initial cooling rate τ(0) could be from 800° C./sec to 1000° C./sec, depending upon the actual size of the feedthrough package and the relative temperature difference between the quenching fluid temperature and the package processing temperature, and where the cooling rate is modulated by the function δ(t). FIG. 8(A) illustrates a cooling rate profile that should enable an effective process for removing extra strain field amplitude, as shown in FIG. 7(C). The high thermal tempering rate of 300-800° C./sec occurs over the first 0.1 sec, followed by a medium rate of 100-300° C./sec occurring from 0.1 to 6 sec, and the entire feedthrough assembly reaches an equilibrium in temperature to the quenching fluid after a matter of minutes.

FIG. 8(C) further illustrates the formation of a gradually varying CTE interface between the sealing material body and a metal shell, and a corresponding gradually varying glass transition temperature from T_{g}(0) to T_{g}(n), where T_{g}(0)>T_{g}(n). This can occur when the liquid-like sealing material becomes “frozen” within a transient quenching time interval. The relevant physical mechanism involves the thermal conductivity (˜1.0 W/m/K) of the sealing material as compared to that of the metal material (˜300 W/m/K); the heat dissipation rate will be relatively fast at the sealing material/bead surface and slower with increased depth into the sealing material region. As the liquid-like sealing material becomes a supercool solid gradually from its outer surface to the interior, the outer layer(s) of sealing material may have an amorphous morphology, while in the underneath layer(s) of the sealing material, the medium or slower cooling rate will cause the sealing material to have a more uniform morphology (and eventually become a more density amorphous morphology even semi nano-crystalline sealing material structure with increased depth from the material interface). This time-dependent heat dissipation process causes the sealing material to have a gradually varying T_{g} or density from the metal/sealing material interface inward into the sealing material.

For an isothermal cooling process, an amorphous sealing material may have its glass transition temperature at T_{g}(0); however, a relatively high cooling rate could shift the glass transition temperature (T_{g}) downwards, with T_{g}(0)>T_{g}. By using n cooling rates (for example, relatively fast cooling over the first<0.1 sec, followed by slower but still relatively fast cooling over the first second, a medium cooling rate until 5 seconds, followed by relatively slow cooling until 10 sec, etc.) during the thermal tempering process, a material layer with a semi- or continuously varying value of CTE will form that functions to effectively reduce the sharp strain field transition from a relatively high-CTE metal to a relatively low-CTE sealing material. Such a multiple cooling rate thermal tempering process also creates a sealing material with a microstructure similar to an amorphous glass structure at the surface and subsurface, but denser and having nano-crystallites inside the sealing material; this is termed a “glass-ceramic” material herein.

As a specific example, a tempering temperature is set as the firing temperature Tₜₕ=T_{f}=650° C., the quenching fluid used is liquid nitrogen at −196° C., and the thermal tempering process shifts the feedthrough assembly to the quenching fluid, N₂ tank, within seconds. In another example, the quenching medium is hydrocarbon/mineral oil (such as Shell heat transfer oil), and the thermal tempering process is to shift the feedthrough assembly to the heat transfer oil within seconds.

Creating a CTE Gradient Using a Density Varying Layer

The use of a time-dependent cooling rate, controlled thermal tempering process (as described previously) enables the formation of a density varying layer which is less dense at the surface but denser inside the material, due primarily to gradually varied material microstructures and morphologies. As illustrated by FIG. 8(B), a density gradient at the sealing material subsurface may lead to a gradual CTE variation that satisfies the relationship

$${α}_{seal} ( z ) = \frac{Δ V / {V}_{o}}{{T}_{g} ( z ) - {T}_{tp}} = - \frac{Δ ρ / ρ}{{T}_{g} ( z ) - {T}_{tp}} \qquad ( 7 )$$

where α is determined by the sealing material volume or density change. Note that a decrease in density (Δρ<0) will lead to an increase in CTE (αₛₑₐₗ). However, the use of a thermal tempering process creates a different glass transition temperature, T_{g}(z), for forming a CTE (αₛₑₐₗ(z)) gradually varying interface layer in the feedthrough package when the relative density variation Δρ/ρ is constant.

An advantage of this gradually varying material structure is that it is capable of improving the brittle nature of a pure (or purer) sealing glass or glass-ceramic material and enables the feedthrough package to tolerate a relatively higher stress level, without inducing potential mechanical fatigue. This feature of the interface layer (i.e., having its density, glass transition temperature, and CTE gradually varied) is believed to be due to its desirable micro- or nano-structural morphologies that could effectively reduce or compensated for a non-uniform strain coupling field amplitude. In one example, the interfacial morphology of a sealing material consists of micro-voids or nano-voids that have a relatively low density but a relatively high CTE. In another example, the interfacial morphology of a sealing material is a non-uniform layer having a composition or density that is gradually varying. In yet another example, the interfacial morphology of a sealing material varies from a condensed ceramic-like structure to an amorphous glass network.

An appropriate sealing material morphology is determined by both tempering temperature and time, and a low-CTE morphology corresponds to an amorphous morphology which may be dominated by micro- or nano-voids, and even tiny gas bubbles, originating from an oxide chemical reaction during the feedthrough package firing process. In contrast, a relatively high-CTE sealing material microstructure may correspond to glass ceramic textures as a result of a relatively slow cooling rate. An optical microscope or/and scanning electronic microscope could be used to identify which morphology exists in the interface regions. Under illumination by visible light, the translucent or white pal color in the scattering area may strongly indicate the potential of micro- or nano-voids, or tiny bubbles which have a size comparable to a light wavelength of ˜0.5 μm. The varied contrasts from interface to sealing material interior may indicate a density variation because of light absorption/scattering difference seen from different areas.

Conventional solid materials have either crystalline (including semi-crystalline and polycrystalline, nano-crystalline, and microcrystalline) or an amorphous structure. Crystalline materials may have different phases at different temperature and/or pressure conditions, and may exhibit reversible phase transitions at different temperatures and pressures. An amorphous material may have no phase transition but instead a series of morphology variation, namely, a variation from one morphology to another, where sometimes this variation is irreversible (for example, a relatively looser material microstructural morphology may be able to transition to a more condensed morphology, but this transition may not be reversible). Normally, an amorphous material may have almost any kind of morphology, but it is difficult to make an amorphous material have a morphology that gradually varies.

As mentioned, an aspect of the described thermal tempering process is the use of a quenching fluid (such as water, hydrocarbon or mineral oil, or gas/liquid air and nitrogen) having an appropriate thermal conductivity, density, viscosity and specific heat capacity. To efficiently dissipate the heat generated by the process of creating a layer having a gradually varying CTE, the baseline temperature and thermal conductivity of the quenching medium should be considered. A low-temperature baseline enables a relatively high cooling rate, such as might be achieved by quenching using a liquid nitrogen medium. A high-temperature quenching fluid could slow down the cooling rate, such as quenching a metal in a hot fluid (boiling water, hot oil), but the quality, Q, of the interfacial layer having the varied composition or material properties will depend upon both the cooling rate and the thermal conductivity difference between the quenching fluid and the sealing glass, as described by:

Q(T,t)˜τ(t)(T_{g}−T)/(k−k_{g}), (8)

where k is thermal conductivity of the quenching fluid, and k_{g} (≈1.0 W/m/K) is the thermal conductivity of the sealing material. Table 2 (as shown in FIG. 1(E) lists some commercially available quenching fluids and their corresponding thermal conductivity values. From the Table, it is clear that a low thermal conductivity of the quenching fluid, such as Air, N₂ or O₂, will likely enhance the interface quality of a high-CTE metal to low-CTE sealing material hermetical seal.

Reducing Stress at the Interfaces by Varying the Composition and/or Microstructural Properties of the Sealing Material

For a specific sealing material and metal shell and pins, the wettability and sealing length fluctuation induced stress may be addressed by improving the sealing material wettability with a metal shell or pin surface. For example, a Gold plated pin can be directly used without requiring an abrasion or oxidization process. As recognized by the inventors, and based on the benefits achieved by the described thermal stress treatments on strong strain field coupled feedthrough packages, benefits may also be achieved by employing a process to create a gradient in the properties of the sealing material across the sealing region (in part or in full). These benefits can be realized by creating a gradient in the composition or microstructure of the sealing material, or by a combination thereof. An appropriate gradient in the properties is expected to at least partially negate the effect of sharp changes in the strain distribution across the sealing region(s).

If a compositional gradient is desired, techniques can be employed to create a gradation in the sealing material composition prior to its application; this may be done through a diffusion process, an implantation process, a mixing process, a process similar to altering the index of refraction of a fiber optic line, or other suitable process. Once the sealing material has been prepared in such a manner and employed as a sealing component, the gradation in composition will necessarily cause a gradation in other properties, such as the coefficient of thermal expansion, specific heat, and thermal conductivity of the sealing region. With this approach, a manufacturer can tailor the sealing material for its desired use case, such as by creating a material having a higher coefficient of thermal expansion at the outer parts of the seal, with a gradual transition to the lower coefficient of expansion near the center of the seal.

If a microstructural gradient is desired in the sealing region, then application of a thermal treatment can be used to create a gradation in the properties of the sealing material in the region, with the treatment being applied either at the pre-employed stage (i.e., before the material is applied), during the sealing stage, or after the sealing region is completed. A purpose of the thermal treatment is to modify the sealing material morphology near the outside of the sealing region, and due to a thermal gradient, to gradually transition in character from the material interface (i.e., the shell-sealing material or pin-sealing material interface(s)) towards the center of the sealing region. As the material morphology, size and number of oxide bonds changes across the sealing section or interface, so too will other material/seal properties, such as the coefficient of thermal expansion, specific heat, thermal conductivity and density of the sealing material. Note that while it is difficult to quantify the precise morphology characteristics that will produce a desired variation in CTE across or within a region, a scanning electron microscope may be used to evaluate if the interface microstructure resulting from a specific thermal tempering process or cooling time and choice of quenching fluid is optimal.

Note that one may use a combination of these compositional and microstructural processes to create a desired gradient in a characteristic of the sealing region or the sealing material. In this example, as the morphology and matrix composition changes across the sealing region, so will other material properties, such as the coefficient of thermal expansion, specific heat, thermal conductivity and density of the sealing material.

Reducing Interface Stress by a Low-Loading and Low-Frequency Thermal Cycle Process

Since a sealing material can endure only a small amount of strain before suffering a rupture and/or loss of hermeticity in the sealing region, this requires that a sealing material be able to absorb the induced strains as necessary to maintain a continuous body upon the application of a thermal variation. A strong strain field coupling effect may superimpose stress on both the shell and the sealing material to a degree that those components cannot readily withstand a high load without inducing rupture and reliability issues. Similarly, a feedthrough package may withstand these additional strains, but ultimately fail if subjected to limited cycles within a narrow temperature range. Although creating a CTE-varying glass-ceramic structure is one way to improve its brittle nature (as suggested by FIG. 8), a high strain field amplitude remains a potential failure mode that can degrade the reliability of a feedthrough package, especially under extremely low or elevated temperatures.

With that in mind, another process that may be used to produce an electrical feedthrough as described herein is a “low-loading, low-frequency thermal cycle process”; this process may be used to remove undesirable stress from an integrated metal shell and brittle sealing material feedthrough package by introducing a low-load strain and undergoing a limited thermal cycling process. As part of this type of thermal cycling process, it is useful to define a lower temperature (Tₘᵢₙ) and an upper temperature (Tₘₐₓ) for the process, with a dwell time at both temperatures, and a thermal ramping rate from Tₘᵢₙ to Tₘₐₓ, or vice versa. In a typical situation, it is useful to select −100° C.<Tₘᵢₙ≤25° C., 100° C.<Tₘₐₓ≤250° C., and a 5-10° C./min rate.

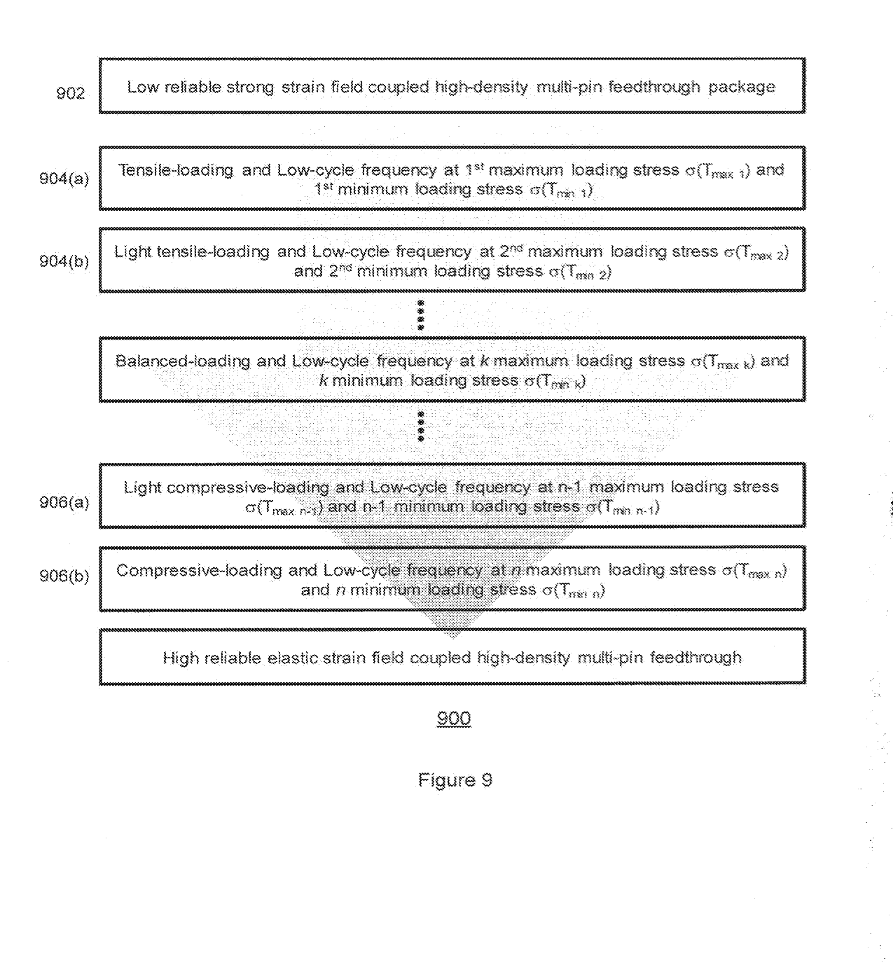

FIG. 9 is a flow chart or flow diagram illustrating the steps or stages in a process flow 900 for producing a multi-pin feedthrough in accordance with an embodiment of the inventive processes; the illustrated example is one that has been used by the inventors to obtain an improvement in the reliability for a high-CTE metal/low-CTE sealing material electrical feedthrough package.

The illustrated process of FIG. 9 begins by taking an initial low-reliability strong strain coupled package (as suggested by step or stage 902) and applying a series of low-loading, low-frequency thermal cycles (as suggested by steps or stages 904(a) and 904(b), with additional such steps possible) to remove undesirable stress from the package. This set of cycles may include ones in which the cycle frequency and/or tensile loading stress that is applied to the package are varied between cycles. Since the glass transition temperature T_{g} is material dependent, it determines the setting point of the upper limit or maximum temperature Tₘₐₓ. On the other hand, the high strain field normally appears at low(er) temperatures, which determines the setting point of the minimum or lower limit temperature Tₘᵢₙ. During cyclic loading within the elastic regime, stress and strain are directly related through the elastic modulus. The stress loading is determined by

Δσ=σ(Tₘₐₓ)−σ(Tₘᵢₙ). (9)

Such a cyclic loading produces elastic strain variation, without causing plastic strains or potential material creeping. However, such a thermal cycle may slightly reduce the internal strain field profile and amplitude; this may relax a sharp mechanical stress signature at different material interfaces, which is generally similar to a structural thermal fatigue effect. For a specific sealing length varying feedthrough, the internal mechanical strain field across the metal web may be non-uniform with relatively high mechanical stress signatures. The described tensile low-load and low-frequency thermal cycle process may be used to cause the electrical feedthrough package to behave as an elastically thermal oscillator within a relatively wide temperature range. After this part of the manufacturing or assembly process, the isolated stress signatures around the pin(s) are expected to be “relaxed” to a relatively mild amplitude that is capable of tolerating thermal shock within an operating range from −65° C. to 150° C.

On the other hand, as recognized by the inventors, a low-load and low-frequency balanced thermal cycle may be used to effectively reduce the high strain coupling effect that is present at both low temperatures and elevated temperature ranges. In this scenario, both tension and compression are not too high, but close to σ_{MAS} and σ_{CS}. This feedthrough package may work well in a narrow temperature range, but could have a short service life for a relatively wider temperature range. In a typical example, the low-CTE (˜8×10⁻⁶ m/m/° C.) sealing material may be directly sealed with a stainless steel like metal, which may lead to high compressive stress in the sealing material body. In this case, a plated pin may be used directly without the use of an abrasion or oxidization process.

In another possible situation, a feedthrough package may exhibit a relatively high degree of stress or a failure mode at an elevated temperature range. To effectively reduce such undesirable stress, a low-load and low-frequency thermal cycle of light-compression to high-compression, for example, from −65° C. to −15° C., may be used to relax the feedthrough package stress amplitude to below the metal web or shell material's maximum allowable design stress (as suggested by steps or stages 906(a) to 906(b), with additional such steps possible). This set of cycles may include ones in which the cycle frequency and/or compressive stress that is applied to the package are varied between cycles.

In one scenario, a feedthrough package may require only one thermal cycling treatment, but it may have to use two or more of the described cycling procedures, as illustrated in FIG. 9. It is noted that under typical conditions, there is no limit to the combinations of the described methods that may be used to reduce or remove undesirable stress amplitude, stress signatures, and the non-uniform strain field coupling effect. As mentioned, the described low-load and low-frequency thermal cycle process is primarily for enabling a high-CTE metal/low-CTE sealing material directly sealed electrical feedthrough package to behave like a harmonic elastic thermal oscillator when there is undesirable stress σ(T)>σ_{MA} at an elevated-temperature by increasing the level of compression in the sealing material body, and thereby exhibit long-term reliability.

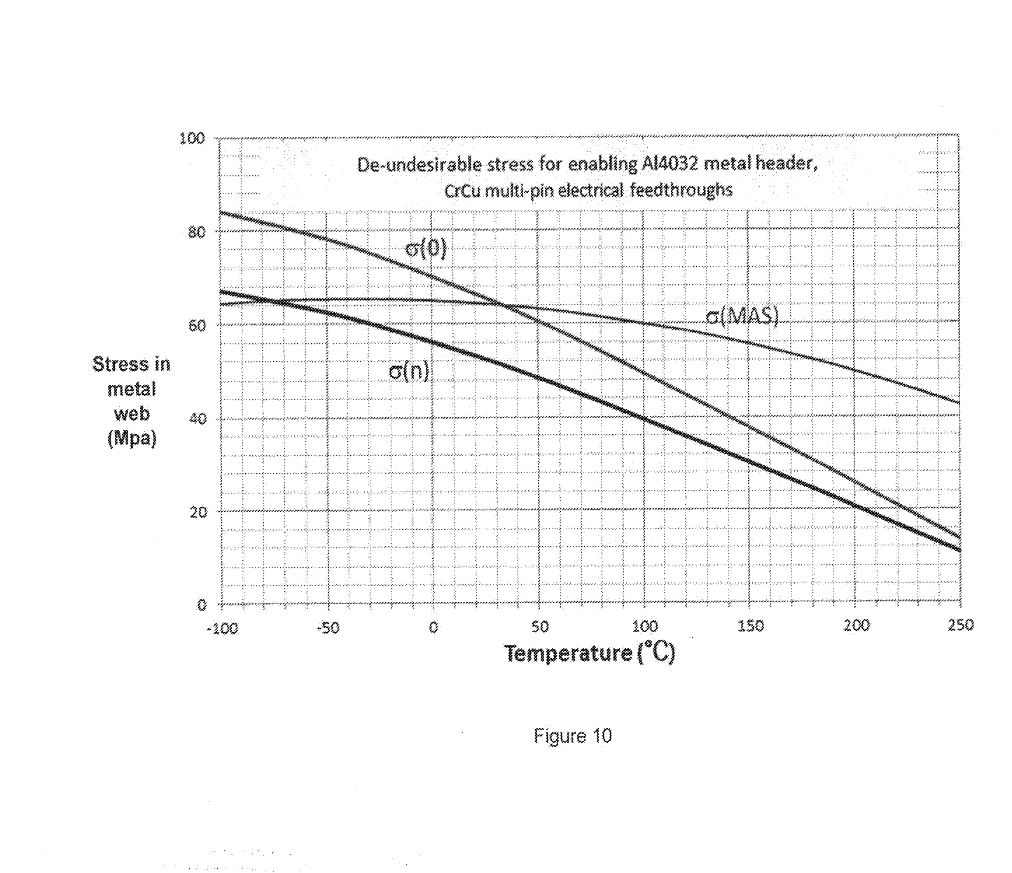

As another example illustrating the use of the above described thermal cycling process to assist in resolving the possible stress issues in a high-CTE Al-alloy and low-CTE sealing material based feedthrough package, FIG. 10 illustrates the change to a low-CTE sealing material (α=11×10⁻⁶ m/m/° C., E=50 GPa, T_{g}=310° C.) in a high-CTE Al-alloy and CrCu conducting pin-based feedthrough package; as shown, the material changes from an initial low-reliability stress function (σ(0); the green curve in FIG. 10) to a high(er) reliability stress function (σ(n); the black curve) after application of an n-thermal cycle process. The red curve in the figure corresponds to a maximum allowable stress, σ(MAS), of the Al-alloy material. After application of the described thermal tempering, low-load, and low-frequency thermal cycle processes, the final feedthrough package may reliably work down to −70° C., which is likely satisfactory for most feedthrough applications.

As noted, an Al-alloy based directly sealed feedthrough is of great interest to the aerospace and aviation industry due to its light weight, high strength and direct welding with electrical packages. Embodiments of the invention allow an electrical feedthrough package to be used over a much wider operational temperature range and hence increase the value of the manufacturing or assembly processes. Further, since it is a manufacturing process based stress reduction method, it may be integrated with an existing manufacturing process without requiring extra equipment. In some embodiments, the inventive processes enable a feedthrough assembly package to use an aluminum alloy material at a much lower temperature range than conventional methods (e.g., up to −100° C., compared to the current industrial standard of −55° C.).

The inventive stress reduction methods can be utilized for high CTE mismatched electrical feedthrough products (such as 19-21×10⁻⁶ 1/° C. from Al-alloy, 15-17×10⁻⁶ 1/° C. from Cu-alloy and Stainless steel, and Nitronic alloy, etc.) or medium CTE mismatched feedthrough products (such as 12×10⁻⁶ 1/° C. for Inconel 718 and Inconel X750 alloy etc.), regardless of the pin materials. Embodiments of the inventive processes leverage existing multi-pin electrical feedthrough manufacturing techniques to enable novel highly hermetical and integrated electrical connector package technology. These inventive methods provide a practical processing method for removing the undesirable stress that is introduced by mismatched CTE header and sealing material. The described techniques can be applied to existing HPHT downhole and cryogenic nonmagnetic feedthrough products that are used in high-temperature, high-pressure, high-voltage, and magnetic field harsh environmental applications.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1.-16. (canceled)

17. An electrical feedthrough assembly, comprising:
one or more conductive pins;
a metal shell surrounding a region containing the one or more conductive pins; and
a layer or layers of a sealing material, the layer or layers including a region or regions in which a value of the sealing material coefficient of thermal expansion (CTE) varies in an area around each of the one or more conducting pins and across at least a portion of an area between the one or more conducting pins and the metal shell.

18. The electrical feedthrough assembly of claim 17, wherein the area around each of the one or more conducting pins includes the interfaces between the conducting pins and sealing material, and the area between the one or more conducting pins and the metal shell includes the interfaces between the sealing material and the metal shell.

19. The electrical feedthrough assembly of claim 17, wherein the sealing material's composition, morphology, or microstructure, either alone or in combination, varies in the area around each of the one or more conducting pins and across at least a portion of the area between the one or more conducting pins and the metal shell.

20. The electrical feedthrough assembly of claim 19, wherein the variation in the material's composition, morphology, or microstructure produces a gradation in the density of the sealing material.

21. The electrical feedthrough assembly of claim 17, further comprising a web structure placed over the region, the web structure being a metallic or metal-alloy material and placed on top of the layer or layers of sealing material.

22. The electrical feedthrough assembly of claim 17, wherein the sealing material includes a glass material, a ceramic material, or a combination of a glass material and a ceramic material, with each material having an associated CTE ranging in value from 6×10⁻⁶ m/m/° C. to 12×10⁻⁶ m/m/° C.

23. The electrical feedthrough assembly of claim 17, wherein the conductive pin or pins are one or more of copper or copper alloy, an iron alloy steel, NiFeCo alloys, or an Inconel, with each having an associated CTE ranging in value from 12×10⁻⁶ m/m/° C. to 17×10⁻⁶ m/m/° C.

24. The electrical feedthrough assembly of claim 17, wherein the shell is one or more of an aluminum alloy, a stainless steel, a Nitronic alloy, or an Inconel, with each having an associated CTE ranging in value from 12×10⁻⁶ m/m/° C. to 25×10⁻⁶ m/m/° C.

25. The electrical feedthrough assembly of claim 17, wherein the ratio of the metal shell CTE to the sealing material CTE is from 1.5 to 2.5.

26. The electrical feedthrough assembly 17, wherein the ratio of the metal shell CTE to the sealing material CTE is from 2.0 to 3.5.

27. The electrical feedthrough assembly of claim 17, where in the conductive pin(s) are plated with a single-layer of Ni, a bilayer of Au/Ni or Au/Pd, or a triple-layer of Au/Pd/Ni.

28.-29. (canceled)

30. The electrical feedthrough assembly of claim 17, wherein at least part of the variation in the sealing material CTE is the result of a change in a transition temperature (Tg) or density of the sealing material.
